(19) United States
(12) Patent Application Publication
(10) Pub. No.: US 2008/0123852 A1
(43) Pub. Date: May 29, 2008

(54) Method and system for managing a wireless network

(76) Inventor: Jianping Jiang, (US)

Correspondence Address: JIANPING JIANG, 1091 QUAIL CREEK CIRCLE, SAN JOSE, CA, 95120, US

(21) Appl. No.: 11/605,658

(22) Filed: Nov. 28, 2006

(51) Int. Cl. H04K 1/00

(52) U.S. Cl. 380/273

(57) ABSTRACT

The present invention includes a method to update a first key maintained at one or more client devices and automatically updates a second key maintained at one or more wireless network access points to match the first key to allow the client devices to access the wireless network.

### FIELD OF THE INVENTION

The present invention pertains to the field of network management. More particularly, the present invention relates to management of a wireless network.

### BACKGROUND OF THE INVENTION

Wireless local area network technology based on IEEE 802.11 family of standards, also referred to as Wi-Fi, has gained widespread usage in various areas of applications. The security aspect of this technology has evolved over a long period of time. Originally, Wired Equivalent Privacy (WEP) was introduced as a method to provide both authentication and privacy. However, due to the weakness in key management and message authentication, WEP has been proved to be a less robust solution. Since then, the security task group of IEEE 802.11 had created a new security standard for 802.11 networks. The new standard is named 802.11i. 802.11i not only provides means of authentication and key management, but also employs stronger encryption algorithms such as AES and TKIP.

Key management specified in 802.11i can be performed by two approaches: Extensible Authentication Protocol (EAP) or pre-shared key (PSK). In practice, the former usually makes use of an authentication server such as a Radius server and one or several EAP protocols for authentication and possible key derivation; the latter utilizes a pre-set key that both access point(s) and client station(s) possess and use for authentication and further key derivation. Complexities, costs and device involvement associated with the two approaches differ largely. The former is mostly used in enterprise and larger scale networks, where IT professionals are available for maintaining the networks; the latter is mostly used by home and small to medium size business (with total devices count less than 100 in most cases), where the network configuration maybe simpler and there are usually scarce IT management resources.

The encryption keys used in both approaches contain 32 bytes (or 256 bits). For convenience, when using pre-shared key (PSK), a pass phrase consisting of ASCII characters are used instead of a 256-bit key to make it easier for user to memorize when configuring the settings on both Access Points (APs) and client stations. The pass phrase will eventually be converted into a 256-bit key by going through a series of specified computations. With the approach of using pre-shared key, there is certain security risk if the pre-shared key is not changed over a longer period of time: the key could be compromised or leaked to outsiders without notice; an eavesdropper can monitor and record enough network traffic data and may be able to decode the key if enough time and enough computing power are available; the chosen pre-shared keys tend to be weak keys as they are usually in the form of ASCII strings that are easy to remember, which makes them vulnerable to dictionary attacks. A more security-in-minded practice is to change pre-shared key from time to time with a reasonably short time interval. However, changing a pre-shared key is not always a trivial task if it has to be done manually. Essentially the change needs to be applied to every single participating wireless LAN device, including access points and client stations. The complexity of this task is proportional to the number of wireless devices in the network; it is also proportional to the frequency of the change. For a small to medium sized business, having to change pre-shared key manually and periodically will be a tedious routine process for each wireless device users, and will take a toll on the time and resource that otherwise might be dedicated to performing primary business activities.

### SUMMARY OF THE INVENTION

The present invention includes a method to update a first key maintained at one or more client devices and automatically updates a second key maintained at one or more wireless network access points to match the first key to allow the client devices to access the wireless network. Other features of the present invention will be apparent from the accompanying drawings and from the detailed descriptions which follows.

### BRIEF DESCRIPTION OF THE DRAWINGS

The present invention is illustrated by way of example and not limitation in the figures of the accompanying drawings, in which like references indicate similar elements and in which:

FIG. 1 illustrates a prior art wireless Local Area Network (LAN);

FIG. 2 illustrates functional interfaces of a network management agent module;

FIG. 3 illustrates functional interfaces of a client module;

FIG. 4A is a flow diagram illustrating a process at a network management agent module when a client station is initially configured to connect to a wireless local area network;

FIG. 4B is a flow diagram illustrating a process at a client module when a client device is initially configured to connect to the wireless local area network;

FIG. 5 is a flow diagram illustrating a process of updating a pre-shared key performed by a network management agent module;

FIG. 6 is a flow diagram illustrating a process of updating a pre-shared key performed by a client module;

FIG. 7 illustrates communications between a network management agent module and a client module in synchronizing the time to perform pre-shared key updating; and

FIG. 8 is a high-level block diagram showing an example of the hardware architecture of a processing system.

### DETAILED DESCRIPTION

A method and system for automatically updating pre-shared keys in a wireless LAN are described. References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

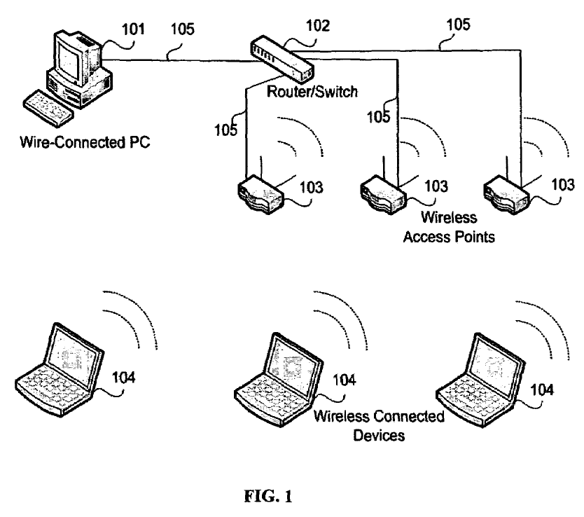

FIG. 1 illustrates a prior art wireless local area network (LAN). As shown, there are multiple access points (APs) 103 and multiple wirelessly connected computing devices 104, such as laptops or PDA devices. The access points 103 are connected (using cable connections 105, for example) to routers or switches 102, through which the access points 103 may be further connected to the internet. There may be one or more Personal Computers (PCs) 101 connected to the router/switches which enable the PCs to access these access points 103 through wired local area networks. In one example, this wireless LAN is a small to medium sized wireless network, and there may not be a presence of a Radius server in the network. The security settings used in the wireless LAN is pre-sharing key. For example, a pre-shared key k₁ may be configured and saved in both APs and wireless client devices.

To update an old key k₁ to a new key k₂, both key settings on APs 103 and key settings on client devices 104 need to be updated. The key settings on APs 103 can be changed by using a number of applications (such as Web page based management application, telnet, CLI through serial connection, SSH, etc.). No matter what application is used, it may be more reliable and secure to perform such operations from one of the wire-connected PCs 101, as configuration changes to wireless settings on APs 103 may not affect the connection between the PC 101 and the APs 103; and it may be more secure and reliable to exchange messages through wired connection than wireless connection. The key settings on client devices can be changed using a number of methods as well—in essence, keys are delivered to client device via different media or paths and may require the device owners to be actively involved in the process.

If a key is updated on APs earlier than client devices, or if the client devices are updated earlier than APs, a disconnection between the APs and the client devices could occur. This disconnection can be a serious interruption to the regular business operations and should be avoided as much as possible. Therefore, it maybe necessary to synchronize the process of updating pre-shared key on both APs and client devices.

The present invention provides a method that is able to update pre-shared key at a relatively frequent pace to ensure network security. The method is also able to automatically update the pre-shared key settings on both APs and client devices in a way that requires minimal human intervention. It is able to synchronize the updating of pre-shared key at APs and stations with a tolerable timing difference so that network disconnection is reduced to minimum.

In one embodiment, a wireless network management module resides and runs in a computing device that has a reliable and secure network connection to the access points, for example, a PC that connects to APs through a wired connection. The computing device may be a network controller, a switch, or any device that has computing power and a network interface. Here, the wireless network management module is referred as “network management agent” or “agent module”. A client service module (or client module) resides and runs in each host which has one or more wireless client devices. Preferably, the PC that hosts the network management agent module will be running constantly and only powered-off for a short period of time, there is no such restriction on client devices. Note that both the agent module and the client module may be implemented as software, hardware or any combination of the two.

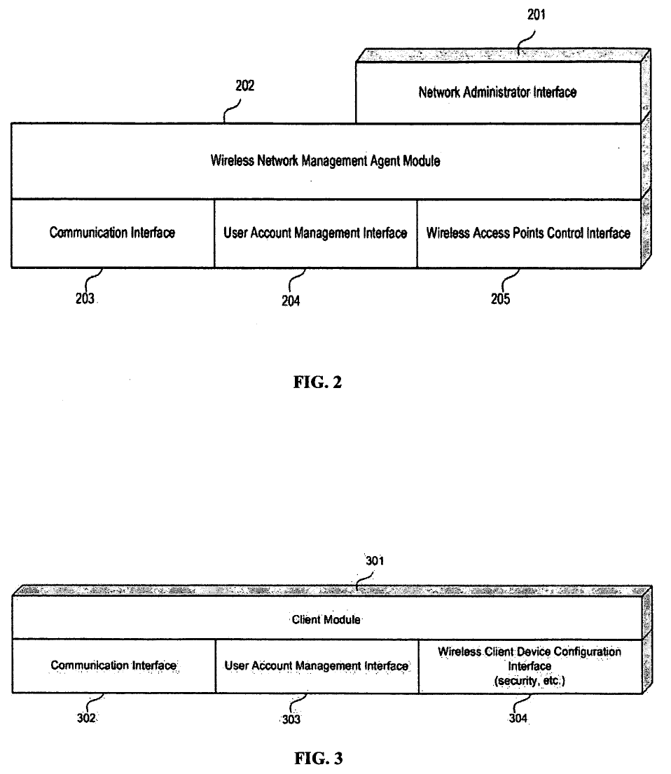

The agent module has four functional interfaces, as illustrated in FIG. 2: a network administrator interface 201, which receives commands and/or requests from a network administrator, it also feedbacks and displays information that the network administrator is interested in; commands include updating a pre-shared key with APs and client devices, querying the status of a client device, etc.; a wireless access points control interface 205, which provides functions including but are not limited to: configuring security/encryption settings on APs, e.g. configuring pre-shared keys, querying information such as MAC addresses and IP addresses of associated client devices; a communication interface 203 that communicates to client modules by sending and receiving messages to and from them; a user account management interface 204, which stores user account information, is capable of authenticating a user account and is responsible for adding/removing user accounts.

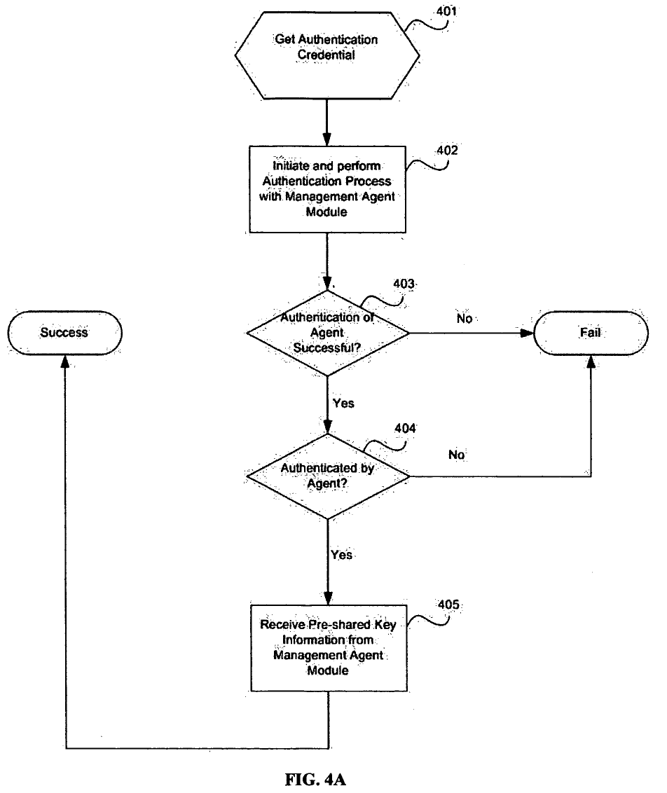

The client module resides in a client computing device. It may bind to a pre-defined communication port, listens for incoming messages and processes any received commands. The client module has three main functions and interfaces as illustrated in FIG. 3: communication interface 302 exchanges and processes commands and messages from agent module, including but are not limited to the settings of pre-shared keys; user account management interface 303 provides user account authentication when required; wireless device configuration interface 304 manages security settings of the wireless devices by configuring a wireless 802.11 supplicant to use a pre-shared key. A wireless 802.11 supplicant may or may not be part of the client module. The client module merely uses the supplicant module to deliver the intended security configurations. A user account contains a credential that identifies the authenticity of a user. It can be as simple as a pair of username and password, but can also be of other forms such as a certificate. There maybe multiple client devices associated with one single user account, for example, in a scenario that a user operates multiple laptop computers all using one user account.

The following describes detailed process of operation in different stages of network configurations. These stages include: initial user account setup, update of pre-shared key for active client devices, re-synchronizing of configuration for a client device out-of-sync for a longer period of time, and removing a user account. Here a client device belongs to one and only one user account; however a user account may have more than one client devices.

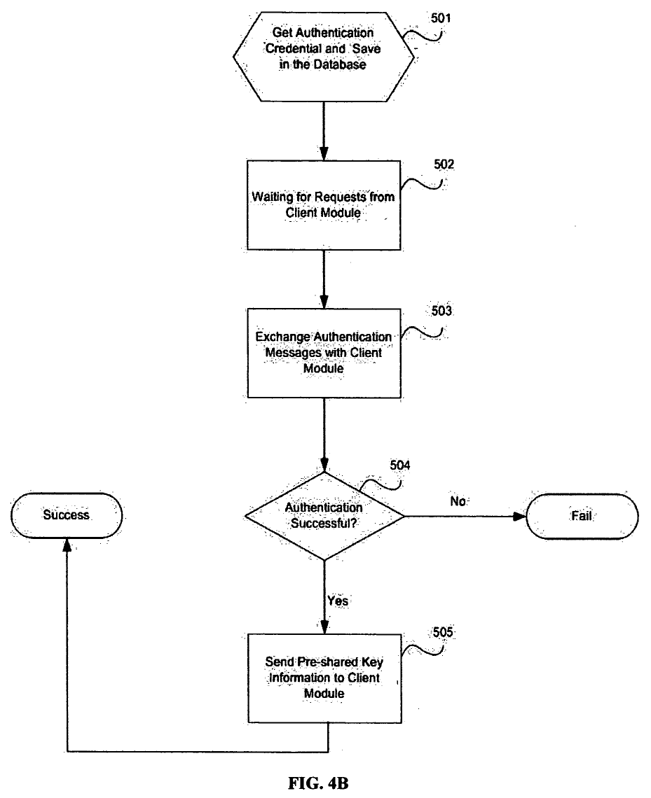

The initial configuration and setup of a client device is illustrated in FIG. 4A and FIG. 4B. The process at the client side is illustrated in FIG. 4A. At block 401, credential information of a user account is provided to the client module; the credential is used for the purpose of authentication; it can be a username and password pair. The client device and the management agent PC initially connect to each other through an out-of-band connection other than the encryption-enforced wireless network connection, due to the fact that the client device is not configured with the correct pre-shared key. This out-of-band connection can be of any form, e.g. wired Ethernet, USB, or wireless with no encryption. Once connected, the client module and the management agent module will authenticate each other using the credential information that both have: at block 402, the client module exchanges messages with the agent module to authenticate the agent module. The authentication process may use any existing protocols, for example, if a Windows domain login server is deployed and is available, a Windows login credential (in the form of username, password and domain) maybe used to achieve this. At block 403, the client module confirms the authenticity of the agent module. At block 404, the client module verifies that the agent module accepts its credential as valid. Then, the client module waits for a message from the agent module. At block 405, the client module receives a message from the agent module and extracts pre-shared key information to use in connecting to the wireless LAN. After receiving the pre-shared key settings information, the client module may start to wirelessly connect to one of the APs of the wireless LAN.

The process of initially configuring a client device at the agent side is illustrated in FIG. 4B. At block 501, credential information of the user account is provided to the management agent module. The management agent module saves the user account credential information in a database that it maintains. At block 502, the agent module waits for client to connect. At block 503, the agent module exchanges messages with a connected client module to verify the authenticity of the client module. At block 504, the agent module determines the authenticity of the client module from the exchanged information. After both the client module and the agent module have mutually authenticated each other, the agent may start sending messages to the client module, one of the information that is passed on to the client module is the pre-shared key settings. At block 505, the agent module sends a message containing the pre-shared key information to the client module. The agent module may also configure APs to accept the client devices based on the MAC address of the client device.

As mentioned earlier that there maybe multiple client devices belonging to the same user account, to configure extra devices using the same user account, the same procedures described in the above is followed except that the agent module already has the user account credential information, thus there is no need to provide the credential information to the agent module again.

After successfully completed the initial setup, a client device may have obtained the pre-shared encryption key and may be able to wirelessly connect to the local area network. To enhance network security, the pre-shared key may be updated more frequently. The pre-shared key updating process is described in the following.

A pre-shared key setting information element (PSKIE) is defined as a data structure that contains an element to represent a pre-shared key in ASCII or binary and an element to represent a time to start using the key. The message that an agent module sends to a client device to update pre-shared key is called an UPDATE message. An UPDATE message contains at least one PSKIE; optionally multiple PSKIEs of which time elements span in a consecutively long period of time can be included in an UPDATE message so that a longer future period of time may be covered.

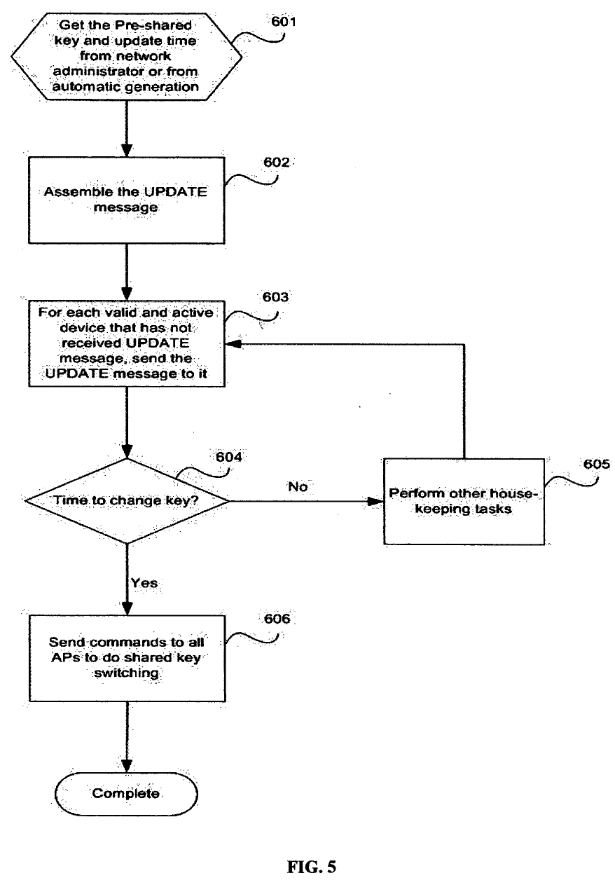

The agent module queries and retrieves client station association information from APs with which it is connected. The information contains client devices' MAC addresses and IP addresses. The agent module maintains a database of the MAC addresses of eligible and valid client devices. The process of updating pre-shared key at the agent side is illustrated in FIG. 5. At block 601, the agent module gathers the pre-shared key and the frequency of updating the key either from an administrator or from a process automatically generating the information. At block 602, the agent module assembles an UPDATE message using the gathered key and frequency information. At block 603, the agent module sends the UPDATE message to each active client device; when a client device module confirms receiving of the UPDATE message, the agent module marks the client device as “updated”. At block 604, the agent modules checks to see whether it has reached the time to do pre-shared key updating. If the time has not come yet, at block 605, the agent module performs other regular tasks; then it goes back to block 603 to search for any client device that is not marked as “updated” and try to send the UPDATE message to the client device or devices. Finally when it reaches the time to update, at block 606, the agent module updates each AP with the new pre-shared key.

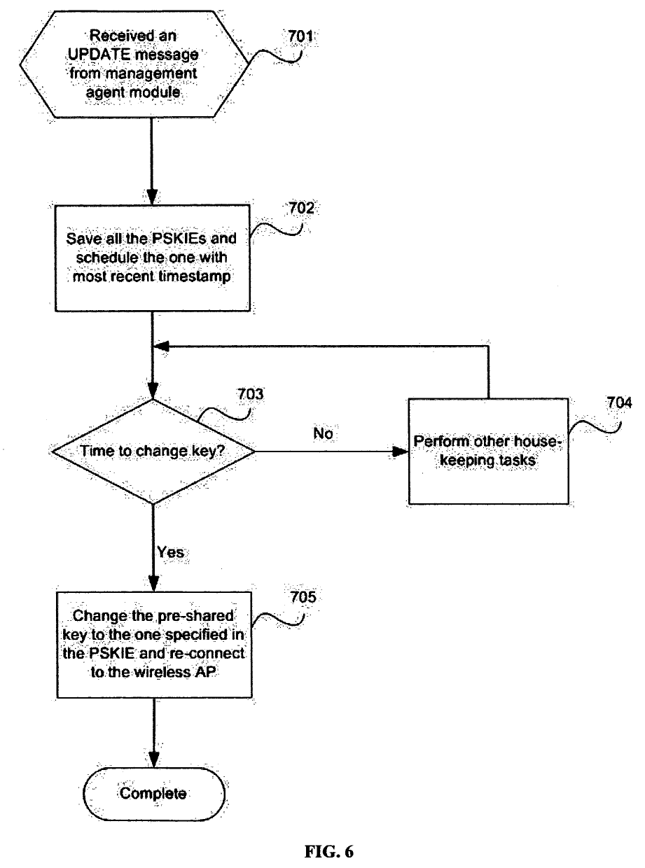

The process of pre-shared key updating from a client module side is illustrated in FIG. 6. At block 701, the client module received an UPDATE message from its associated agent module; it then sends back an acknowledgement message to the agent module. At block 702, the client module extracts all the PSKIEs from the UPDATE message and saves the information. If there are more than one PSKIE, the client module picks the one with the closest update time element. At block 703, the client module checks to see if it has reached the time to do key updating (based on the time in the PSKIE). If the time has not reached yet, the client module performs other tasks at block 704 and loops back to block 703 to do time checking. When the time has finally reached, at block 705, the client module updates the pre-shared key to the new key and reconnects to the wireless LAN.

The UPDATE message may be sent at a time well ahead of the time the actual key updating is being carried out. This may allow the agent module to have enough time to inform most of the client devices about the scheduled pre-shared key updating. It may also allow devices that are not currently powered on to have more time and better chance to receive the message before the scheduled event happens. In one embodiment, the message between the agent module and the client module maybe exchanged via securely encrypted wireless in-band communications.

If a client device is actively associated to the network most of the time and is able to receive every single pre-shared key updating message from the agent, it may be able to keep connected to the wireless network without ever requiring the end-user to intervene in the key updating process. However, there are cases that a client device may miss one or more pre-shared key updating messages. For example, an employee is on vacation and his/her laptop is not turned on during the period of time, so that several UPDATE messages have been missed. In this case, the client device needs to re-sync pre-shared key settings with the rest of the network. To do this, it needs to follow the same process as in the initial setup, except that the agent module already has the user account information in record.

There are cases that a user account needs to be removed. Removing a user account means that the user account and its associated client devices may no longer connect to the wireless network after the removal. The process of removing a user account may be executed by the following procedures: the agent module moves the user account to the list of removed user account; since the agent module keeps a database of the user account and its associated client devices (usually by the devices' MAC addresses), the agent module sends an UPDATE message to those client devices that are active and are using the concerned user account. The UPDATE message includes an incorrect key and an immediate time for key updating. When these devices complete key updating, they will no longer be able to connect to the APs due to the incorrect key. In a relatively short time, the agent initiates an update of pre-shared key for all other valid client stations. In doing so, the agent updates only those clients and devices that are valid but skip those to be removed. Thus, once the process is completed, the removed clients will no longer be able to join the network. As a further step, the agent module requests APs to deny access to all the client devices associate with the to-be-removed user account. This can be carried out by filtering out the MAC addresses of those devices.

When updating pre-shared encryption keys on both APs and client devices, there are two actions associated with this process: one is that the agent module changes the settings on APs; the other is that the client module updates the pre-shared keys for the client station device. If the former happens earlier than the latter, the APs are updated with new keys while the client devices are still using old keys, the link between APs and clients may be disconnected; Vice versa, if the latter happens earlier than the former, there maybe a disconnection between the two. To minimize the disconnection time, it is essential that the two above-mentioned actions be carried out as closely in time as possible, in other words to synchronize the two actions.

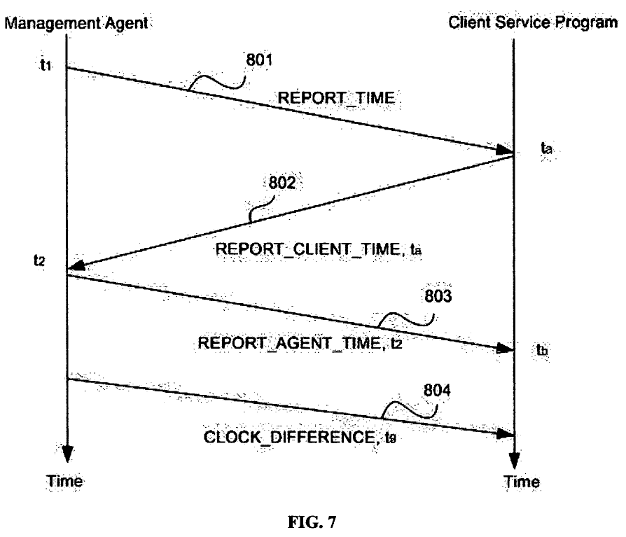

In order to synchronize the timing on agent module PC and the timing on client module PCs, we devise the following protocol. The goal is to achieve a synchronization of the timing between the two within a tolerable time difference. The agent module and the client module will regularly exchange the following messages, illustrated in FIG. 7:
1. At step 801, the agent module gets its local timestamp, t₁, and then immediately sends a message with command “REPORT_TIME” to a client module.
2. At step 802, the client module, on receiving a “REPORT_TIME” command from the agent, immediately gets its current local timestamp, tₐ, it includes tₐ in its return message and immediately sends to the agent module with a message “REPORT_CLIENT_TIME”.
3. At step 803, the agent module, on receiving the “REPORT_CLIENT_TIME” message, immediately records its current timestamp t₂, includes t₂ in its return message and immediately sends to the client module with message “REPORT_AGENT_TIME”.
4. The client module, on receiving message “REPORT_AGENT_TIME”, immediately records its current timestamp t_{b} and gets the value of timestamp t₂; it then calculates t_{c}=tₐ+(t_{b}−t₂)/2 as the time that the agent module receives the message according to its own clock, so the timing difference is t_{z}=(t₂−t_{c}), and this is the clock difference between the agent module and the client module
5. The agent module calculates t₃=t₁+(t₂−t₁)/2 as the time that the client module receives the message according to its own clock, and then it calculates the timing difference t₉=(t₃−tₐ), and this is the clock difference between the agent module and the client module
6. At step 804, the agent module sends a message “CLOCK_DIFFERENCE” to the client module with t₉
7. The client module, on receiving message “CLOCK_DIFFERENCE” and t₉, it calculates a revised clock difference between the agent module and itself as T_{diff}=(t₉+t_{z})/2.

The above protocol assumes that the difference of the TCP transmission delay from the agent module to the client module and the TCP transmission delay from the client module to the agent module are statistically stabilized around a value; it also assumes the computation time for message processing can be ignored in seconds.

The above process may be running at a predefined interval; after each run, a timing difference between the agent module and the client module is calculated, the value is then saved at the client module; the client module may use all the saved timing difference values and an algorithm to derive an average timing difference value. The average timing difference value is used by the client module to adjust the time (according to its own clock) to schedule the pre-shared key updating process. By following this timing synchronizing procedure, the agent module and client module may be synchronized in seconds for the time that they start the pre-shared key updating process.

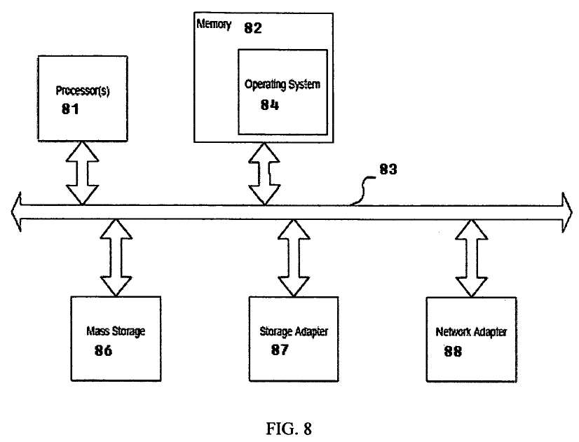

FIG. 8 is a high-level block diagram showing an example of the hardware architecture of a processing system. The hardware architecture may apply to the wireless client devices, the access points and/or the personal computers of FIG. 1. Certain standard and well-known components which are not germane to the present invention are not shown. The processing system includes one or more processors 81 coupled to a bus system 83.

The bus system 83 in FIG. 8 is an abstraction that represents any one or more separate physical buses and/or point-to-point connections, connected by appropriate bridges, adapters and/or controllers. The bus system 83, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processors 81 are the central processing units (CPUs) of the processing system and, thus, control the overall operation of the processing system. In certain embodiments, the processors 81 accomplish this by executing software stored in memory 82. A processor 81 may be, or may include, one or more programmable general-purpose or special-purpose microprocessors, digital signal processors (DSPs), programmable controllers, application specific integrated circuits (ASICs), field-programmable gate arrays (FPGAs), programmable logic devices (PLDs), or the like, or a combination of such devices.

The processing system also includes memory 82 coupled to the bus system 83. The memory 82 represents any form of random access memory (RAM), read-only memory (ROM), flash memory, or a combination thereof. Memory 82 stores, among other things, the operating system 84 of processing system.

Also connected to the processors 81 through the bus system 83 are a mass storage device 86, a storage adapter 87, and a network adapter 88. Mass storage device 86 may be or include any conventional medium for storing large quantities of data in a non-volatile manner, such as one or more disks. The storage adapter 87 allows the processing system to access a storage subsystem and may be, for example, a Fibre Channel adapter or a SCSI adapter. The network adapter 88 provides the processing system with the ability to communicate with remote devices over a network and may be, for example, an Ethernet adapter or a Fibre Channel adapter.

Memory 82 and mass storage device 86 store software instructions and/or data, which may include instructions and/or data used to implement the techniques introduced here.

Software to implement the technique introduced here may be stored on a machine-readable medium. A “machine-accessible medium”, as the term is used herein, includes any mechanism that provides(i.e., stores and/or transmits) information in a form accessible by a machine(e.g., a computer, network device, personal digital assistant (PDA), manufacturing tool, any device with a set of one or more processors, etc.). For example, a machine-accessible medium includes recordable/non-recordable media (e.g., read-only memory (ROM); random access memory (RAM); magnetic disk storage media; optical storage media; flash memory devices; etc.), etc.

“Logic”, as is used herein, may include, for example, software, hardware and/or combinations of hardware and software.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method comprising:
updating a first key maintained at a client device; and
automatically updating a second key stored at an access point of a wireless network to match the first key to allow the client device to access the wireless network.

2. The method of claim 1, wherein the wireless network implements the IEEE 802.11 standard.

3. The method of claim 1, wherein the first key is considered as matching the second key if the first key is exactly the same as the second key

4. The method of claim 1, wherein the first key is considered as matching the second key if the two keys match to each other according to an authentication algorithm.

5. A processing system comprising:
a processor;
a network interface through which to access a wireless network; and
a memory coupled to a processor, the memory storing instructions which, when executed by the processor, cause the processing system to perform a process comprising:
sending a first request to a client device to update a first key stored at the client device; and
sending a second request to an access point of a wireless network to update a second key maintained at the access point so as to maintain the match between the first key and the second key, such that the client device is allowed to access the wireless network.

6. The processing system of claim 5, wherein the first key is considered as matching the second key if the first key is exactly the same as the second key.

7. The processing system of claim 5, wherein the first key is considered as matching the second key if the two keys match to each other according to an authentication algorithm.

8. The processing system of claim 5, wherein the process further comprises exchanging authentication information with the client device.

9. The processing system of claim 5, wherein the authentication information comprises a user/password pair.

10. The processing system of claim 5 further comprises a storage device storing user authentication information and status information regarding the client device.

11. The processing system of claim 5, wherein the first request contains a message including a new key and a time to perform updating the first key.

12. The processing system of claim 5, wherein the process further comprises removing an account and its associated client device in response to a user instruction.

13. The processing system according to claim 5, wherein the process further comprises synchronizing the time of updating of the first key and the time of updating the second key, so as to minimize the timing gap between the client device starting using the first key and the access point device starting using the second key.

14. A machine-readable medium having sequences of instructions stored therein which, when executed by a processor, cause the processor to perform a process comprising:
updating a first key maintained at a client device; and
automatically updating a second key stored at an access point of a wireless network to match the first key to allow the client device to access the wireless network.

15. The machine-readable medium of claim 14, wherein the wireless network implements the IEEE 802.11 standard.

16. The machine-readable medium of claim 14, wherein the first key is considered as matching the second key if the first key is exactly the same as the second key.

17. The machine-readable medium of claim 14, wherein the first key is considered as matching the second key if the two keys match to each other according to an authentication algorithm.

18. The machine-readable medium of claim 14, wherein the process further comprises synchronizing the time of updating of the first key and the time of updating the second key, so as to minimize the timing gap between the client device starting using the first key and the access point device starting using the second key.

19. The machine-readable medium of claim 14, wherein the process further comprises sending the first request message including a new key and a time to perform updating the first key.

20. The machine-readable medium of claim 14, wherein the process further comprises removing an account and its associated client device in response to a user instruction.
